(19) United States
(12) Patent Application Publication
(10) Pub. No.: US 2017/0262020 A1
(43) Pub. Date: Sep. 14, 2017

(54) Head Mount Display with Near-Eye Projection for Virtual Reality System

(71) Applicant: The Void, LLC, Lindon, UT (US)

(72) Inventor: Sajid Patel, Arlington Heights, IL (US)

(73) Assignee: The Void LLC, Lindon, UT (US)

(21) Appl. No.: 15/456,299

(22) Filed: Mar. 10, 2017

Related U.S. Application Data
(60) Provisional application No. 62/306,543, filed on Mar. 10, 2016.

(51) Int. Cl. G06F 1/16; G02B 27/14; G02B 27/00; G06T 19/00

(52) U.S. Cl. CPC G06F 1/1639; G06T 19/006; G02B 27/14; G02B 27/0075; G06F 1/163

(57) ABSTRACT

A system that provides a head mount display (HMD) unit that provides visual content, such as video, through a projection system incorporated within the head mount display unit. The projection system is positioned near a user's eye within the HMD and provides a visual experience that is higher resolution, has a higher refresh rate, runs cooler, requires less power, and provides a broader field of view than typical HMD units, such as an HMD which utilizes a curved display screen.

### CROSS-REFERENCE TO RELATED APPLICATIONS

This application claims the priority benefit of U.S. provisional patent application Ser. No. 62/306,543, titled “Head Mount Display with Near Eye Projection For Virtual Reality System,” filed, Mar. 10, 2016, the disclosure of which is incorporated herein by reference.

### BACKGROUND

Virtual reality systems allow a user to explore a virtual space. Some virtual-reality systems require a user to wear a headset through which the user may visually experience the virtual reality environment. The headsets of the prior art typically do not provide a detailed, clear image for a user, which can affect the virtual reality experience.

### SUMMARY

The present technology, roughly described, provides a head mount display (HMD) unit that provides visual content, such as video, through a projection system incorporated within the head mount display unit. The projection system is positioned near a user's eye within the HMD and provides a visual experience that is higher resolution, has a higher refresh rate, runs cooler, requires less power, and provides a broader field of view than typical HMD units, such as an HMD which utilizes a curved display screen.

The HMD near eye projection may include a digital micromirror device (DMD) or digital light processing (DLP) device which provides an output. The output signal passes through a lens that projects the output signal toward a mirror. The mirror may be an aspherical, elliptical, or freeform mirror. The image from the split beam is formed in free space, and reflected by the mirror to the viewer's pupil.

In some instances, The HMD near eye projection may include a digital micromirror device (DMD) or digital light processing (DLP) device which provides an output to a prism or beam splitter. The beam splitter splits the signal to create a range of band signals. The band signals can be passed through a filter, such as for example a neutral density filter lens, and the output signal can be projected toward a mirror.

### BRIEF DESCRIPTION OF THE DRAWINGS

FIG. 1 illustrates a block diagram of a virtual reality system with a wideband based position tracking system.

FIG. 2 illustrates a user wearing a head mount display.

FIG. 3 illustrates a head mount display.

FIG. 4 illustrates a block diagram of a head mount display near-eye projection system.

FIG. 5 illustrates a block diagram of a binocular head mount display near-eye projection system.

FIG. 6 illustrates a method for performing near-eye projection within a head mount display.

FIG. 7 illustrates an optical signal pattern for a head mount display near-eye projection system.

FIG. 8 illustrates an optical signal pattern for another head mount display near-eye projection system.

FIG. 9 illustrates an optical signal pattern for another head mount display near-eye projection system.

FIG. 10 illustrates a side view of the optical signal pattern for the head mount display near-eye projection system associated with FIG. 9.

### DETAILED DESCRIPTION

The present technology, roughly described, provides a head mount display (HMD) unit that provides visual content, such as video, through a projection system incorporated within the head mount display unit. The projection system is positioned near a user's eye within the HMD and provides a visual experience that is higher resolution, has a higher refresh rate, runs cooler, requires less power, and provides a broader field of view than typical HMD units, such as an HMD which utilizes a curved display screen.

The HMD near eye projection may include a digital micromirror device (DMD) or digital light processing (DLP) device which provides an output. The output signal passes through a lens that projects the output signal toward a mirror. The mirror may be an aspherical, elliptical, or freeform mirror. The image from the split beam is formed in free space, and reflected by the mirror to the viewer's pupil.

In some instances, The HMD near eye projection may include a digital micromirror device (DMD) or digital light processing (DLP) device which provides an output to a prism or beam splitter. The beam splitter splits the signal to create a range of band signals. The band signals can be passed through a filter, such as for example a neutral density filter lens, and the output signal can be projected toward a mirror.

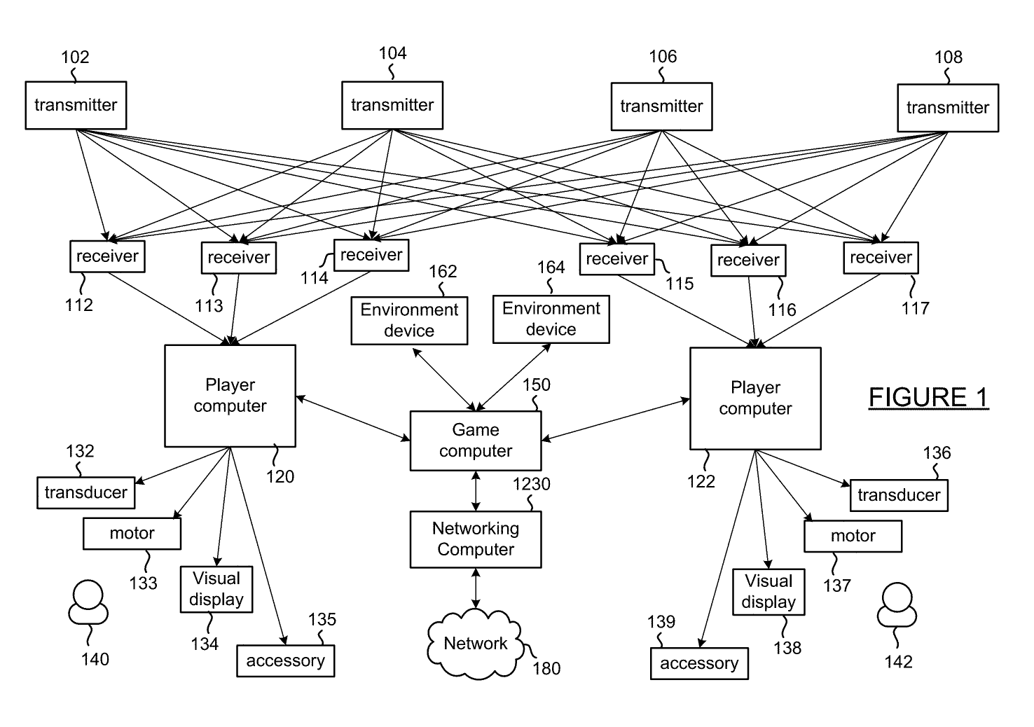

FIG. 1 is a block diagram of a virtual reality system with a wideband based position tracking system in which the HMD of the present technology may be used. The system of FIG. 1 includes transmitters 62, 64, 66 and 68, receivers 112, 113, 114, 115, 116 and 117, player computers 120 and 122, transducers 132 and 136, motors 133 and 137, virtual display 134 and 138, accessories 135 and 139, players 140 and 142, game computer 150, environment devices 162 and 164, networking computer 170, and network 180.

Receivers 112-117 may be placed on a player 140 or an accessory 135. Each receiver may receive one or more signals from one or more of transmitters 102-108. The signals received from each transmitter may include an identifier to identify the particular transmitter. In some instances, each transmitter may transmit an omnidirectional signal periodically at the same point in time. Each receiver may receive signals from multiple transmitters, and each receiver may then provide signal identification information and timestamp information for each received signal to player computer 120. By determining when each transmitter signal is received from a receiver, player computer 120 may identify the location of each receiver.

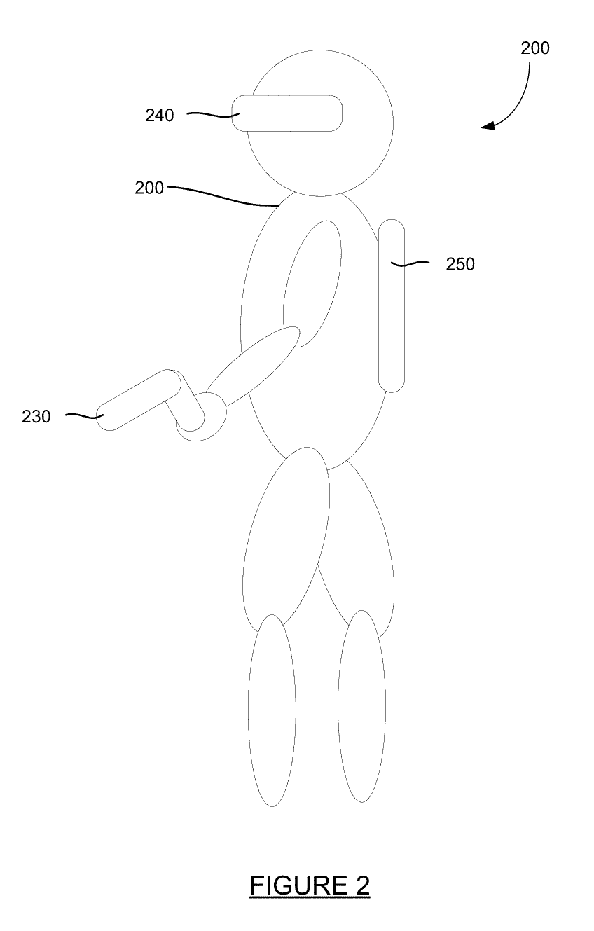

Player computer 120 may be positioned on a player, such as for example on the back of a vest worn by a player. For example, with respect to FIG. 2, player computer 250 is positioned on a back of a player. A player computer may receive information from a plurality of receivers, determine the location of each receiver, and then locally update a virtual environment accordingly. Updates to the virtual environment may include a player's point of view in the environment, events that occur in the environment, and video and audio output to provide to a player representing the player's point of view in the environment along with the events that occur in the environment.

Player computer 120 may also communicate changes to the virtual environment determined locally at the computer to other player computers, such as player computer 122, through game computer 150. In particular, a player computer for a first player may detect a change in the player's position based on receivers on the player's body, determine changes to the virtual environment for that player, provide those changes to game computer 150, and game computer 150 will provide those updates to any other player computers for other players in the same virtual reality session, such as a player associated player computer 122.

A player 140 may have multiple receivers on his or her body and in communication with a player computer associated with the player. The receivers receive information from the transmitters and provide that information to the player computer. In some instances, each receiver may provide the data to the player computer wirelessly, such as for example through a radio frequency signal such as a Bluetooth signal. In some instances, each receive may be paired or otherwise configured to only communicate data with a particular players computer. In some instances, a particular player computer may be configured to only receive data from a particular set of receivers. Based on physical environment events such as a player walking, local virtual events that are provided by the players computer, or remote virtual events triggered by an element of the virtual environment located remotely from the player, haptic feedback may be triggered and sensed by a player. The haptic feedback may be provided in the terms of transducer 132, motor 133, and optionally other haptic devices. For example, if an animal or object touches a player at a particular location on the player's body within the virtual environment, a transducer located at that position may be activated to provide a haptic sensation of being touched by that object.

Visual display 134 may be provided through a headset worn by player 140. The virtual display 134 may include a helmet, virtual display, and other elements and components needed to provide a visual and audio output to player 140. In some instances, player computer 120 may generate and provide virtual environment graphics to a player through the virtual display 140.

Accessory 135 may be an element separate from the player, in communication with player computer 120, and displayed within the virtual environment through visual display 134. For example, an accessory may include a gun, a torch, a light saber, a wand, or any other object that can be graphically displayed within the virtual environment and physically engaged or interacted with by player 140. Accessories 135 may be held by a player 140, touched by a player 140, or otherwise engaged in a physical environment and represented within the virtual environment by player computer 120 through visual display 134.

Game computer 150 may communicate with player computers 120 and 122 to receive updated virtual information from the player computers and provide that information to other player computers currently active in the virtual reality session. Game computer 150 may store and execute a virtual reality engine, such as Unity game engine, Leap Motion, Unreal game engine, or another virtual reality engine. Game computer 150 may also provide virtual environment data to networking computer 170 and ultimately to other remote locations through network 180. For example, game computer 150 may communicate over private networks, public networks, intranets, the Internet, cellular networks, wired networks, wireless networks and other networks to send and receive data with player computers and other machines.

Environment devices 162 may include physical devices part of the physical environment that may interact or be detected by a player 140 or other aspects of the gaming system. For example, and enter environment device 162 may be a source of heat, cold, wind, sound, smell, vibration, or some other sense that may be detected by a player 140.

Transmitters 102-108 may transmit a synchronized wideband signal within a pod to one or more receivers 112 - 117. Logic on the receiver and on a player computing device, such as player computing device 120 or 122, may enable the location of each receiver to be determined in a universal space within the pod.

FIG. 2 illustrates a user wearing a head mount display. The user 200 may be wearing a head mount display over or on the user's head, a computing device 250 somewhere on the user (such as the user's back), and may be utilizing one or more accessories 230.

A virtual reality engine may be hosted on computing device 250, and may provide a graphical and audio updates to the user through head unit 240, which is in communication with computing device 250. The graphical updates may include analog or digital data which HMD 240 may project on a screen within the HMD.

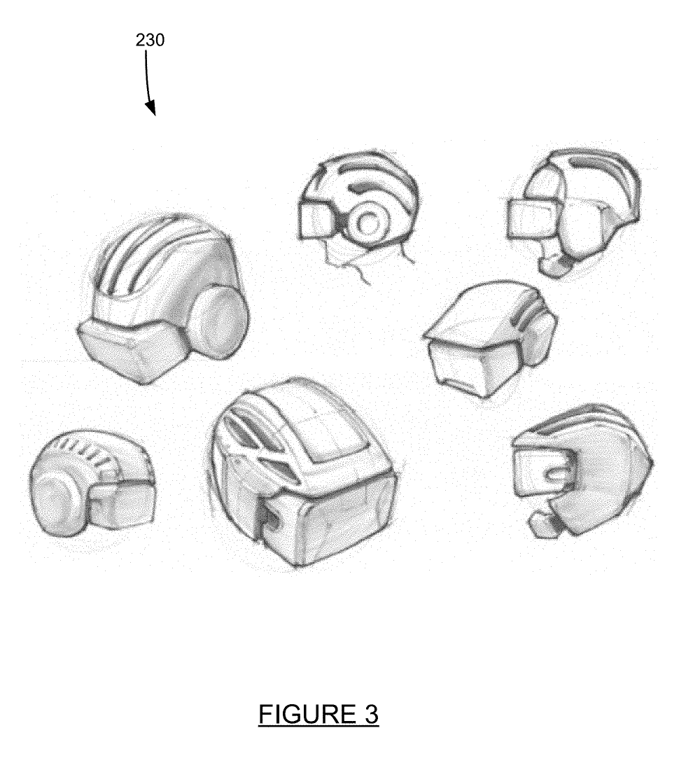

FIG. 3 illustrates a head mount display. The head mount display of FIG. 3 includes a plurality of helmet designs that may be worn by users participating in an immersive environment. The helmets illustrated in FIG. 3 may each comprise an audio-visual system. The audio-visual system may include a display component and an audio component, both of which may provide an output based on one or more signals received from computing device 250, and may cooperate to create an immersive environment. In various embodiments, the display component may entirely obscure a user's vision and generate a complete stereoscopic three dimensional visual representation.

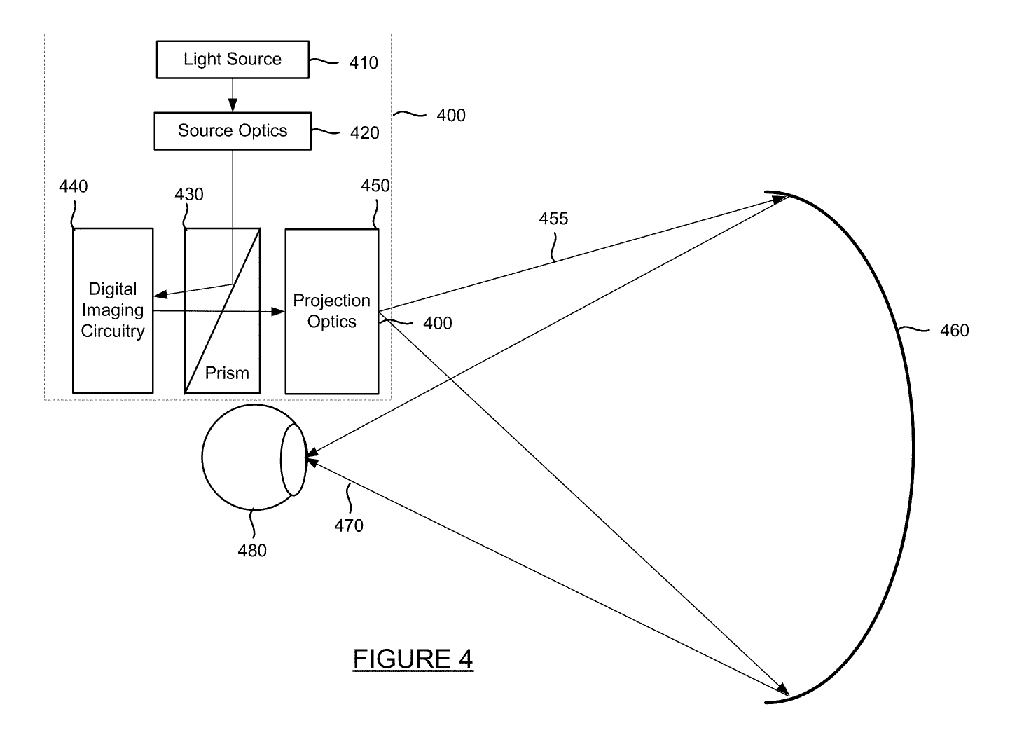

FIG. 4 illustrates a block diagram of a head mount display (HMD) near-eye projection system. The head mount display of FIG. 4 provides more detail of an implementation of head mount display 240 of FIG. 2 and each of visual displays 134 and 138 of FIG. 1.

The system of FIG. 4 includes light source 410, source optics 420, digital imaging circuitry 440, prism 430, and projection optics 450. The light source 410, source optics 420, digital imaging circuitry 440, prism 430 and projection optics 450 may implement electronic controls and optic engine 400.

Light source 410 may provide a source of illumination into the HMD. The illumination source can provide light using LEDS, lamps, lasers or some other light source.

Source optics 420 may shape and form the light generated by light source 410. The generated light may be shaped and formed to match a light input or input parameters for the digital imaging circuitry 440. The source optics may include neutral density filters that modify the intensity of the light, lenses that form the light, integrator rods, and other components for shaping and forming the light.

The prism receives the shaped and formed light output by the source optics 420 and provides the light to digital imaging circuitry. The prism may be implemented as one or more total internal reflection (TIR) prisms, a splitter, or other device.

The digital imaging circuitry may receive light from the prism and use the light to provide image data at the focal plane. Graphical data, including image data, may be received by the digital imaging circuitry from computing device 250 (e.g., player computer 120 or 122 of FIG. 1) and provided to the focal plane using light originally generated by light source 410 (received through prism 430). The digital imaging circuitry may be implemented using a DMD projector, digital light processing (DLP) projector, or other device for projecting a beam.

The output of the digital imaging circuitry may be received by and pass through prism 430. The passed image data may then be received by projection optics 400. The projection optics may focus the image data to an intermediate image suitable for viewing by a user. The projection optics can be implemented using a lens, neutral density filter, focus adjustment component, and other components.

The output of the projection optics may include a split beam 455 that is provided onto mirror 460. In some instances, mirror 460 may be implemented as an aspheric, elliptical, or free-form mirror. The split beam projections 470 reflected by the mirror are directed towards a user's pupil 480

The diameter of the mirror may be suitable for use within a head mount display that is worn by a user. For example, the focal length may be 75 millimeters, 50 millimeters, or some other length less than 80 millimeters.

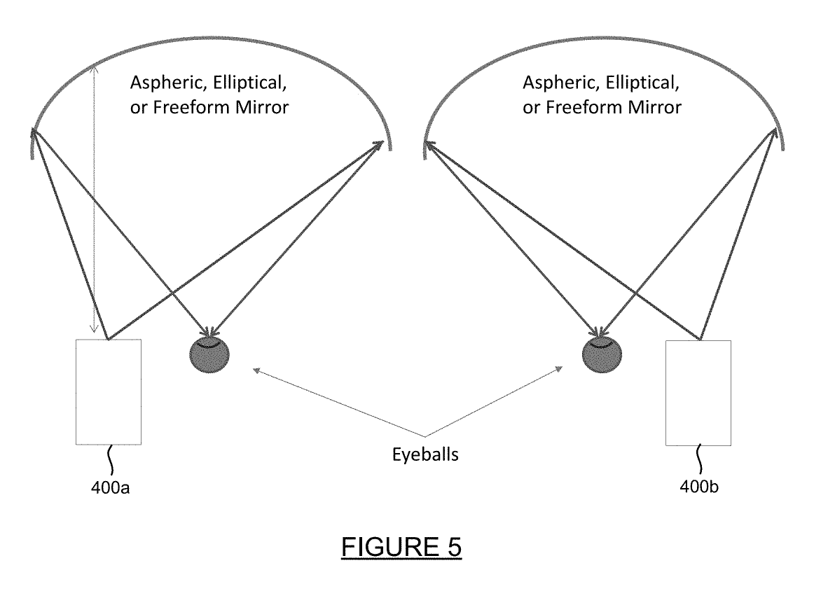

FIG. 5 illustrates a block diagram of a binocular head mount display near-eye projection system. In some instances, a headmounted display may implement a binocular configuration of near eye projectors. As such, a single head mount display may include an electronic controls and optic engine (i.e., near eye projector) for each user's eye—electronic controls and optic engine 400a for one eye and electronic controls and optic engine 400b for the other eye. Each near eye projector may include light source 410, source optics 420, digital imaging circuitry 440, prism 430 and projection optics 450 as discussed with respect to the system of FIG. 4.

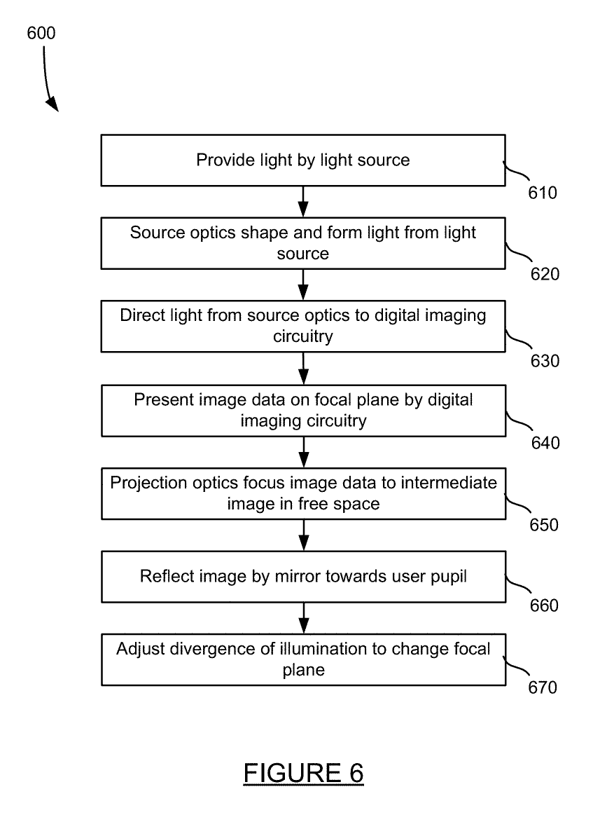

FIG. 6 illustrates a method for performing near-eye projection within a head mount display. A light is provided by a light source at step 610. The light is then shaped and formed by source optics at step 620. The light can be shaped and sourced to match the digital imaging circuitry. Light from the source optics is then directed to digital imaging circuitry using a prism at step 630.

Image data is presented on a focal plane by the digital imaging circuitry at step 640. The image data is then focused by projection optics at step 650. The image data may be focused to an intermediate image in free space through the prism. The focused image data may be reflected by a mirror towards a user's pupil at step 660. The image data can then be viewed by a user. The divergence of the light signals can be adjusted to change the focal plane at step 670. By changing the divergence, the image presented may appear to be closer or further away. The divergence of the light signals can be adjusted by moving the position of the digital imaging circuitry, the projection optics, or both. The position of the digital imaging circuitry and/or projection optics may be changed less than 1 millimeter, between 1-3 millimeters, or some other amount. In some implementations, an optic engine may be configured to adjust the divergence to at least three focal planes, a near plane, medium plane, and far plane. For focal planes that diverges to appear far away, light appears to be a light source from a point located infinity away from the user. For focal planes diverges to appear closer, objects can appear to have more divergence.

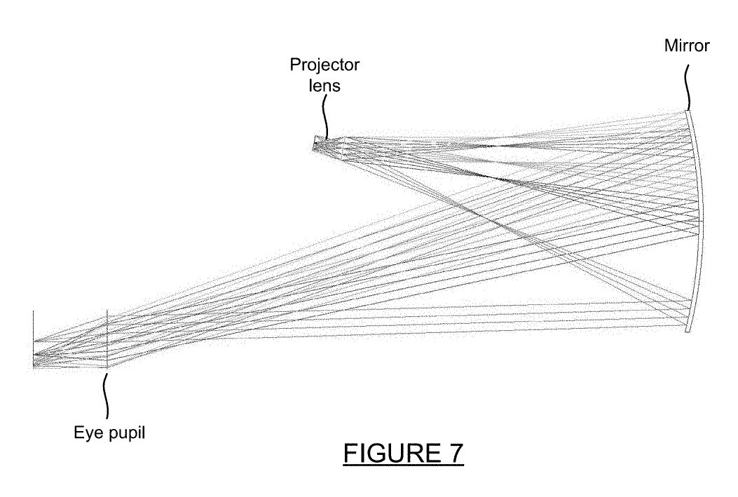

FIG. 7 illustrates an optical signal pattern for a head mount display near-eye projection system. As shown in FIG. 7, a projector lens projects light received by a mirror. Between the projector lines and mirror, the beams form a intermediate image at a particular point. The light is then reflected by the mirror and received at the user's pupil.

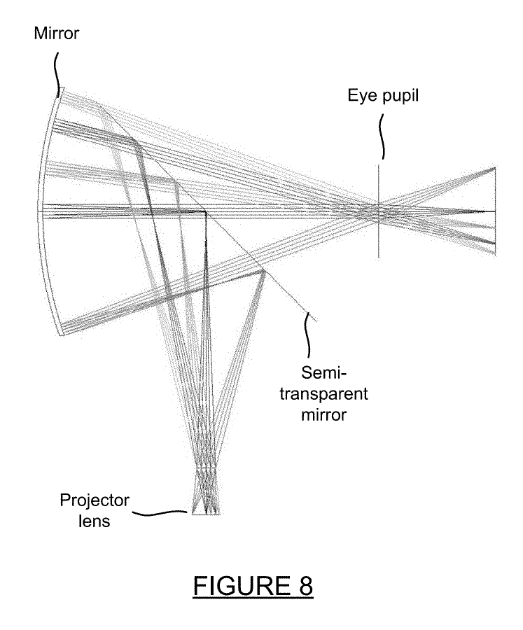

In some instances where a DLP projector is used, a semi transparent mirror may be used to at least partially reflect beams into a mirror. FIG. 8 illustrates an optical signal pattern for another head mount display near-eye projection system. The illustration of FIG. 8 shows a projector lens and beam splitter (not shown in FIG. 8) providing light to a semi transparent mirror. The semi transparent mirror reflects all or a portion of the light into a nontransparent mirror. The nontransparent mirror may then reflect the light to the user's pupil.

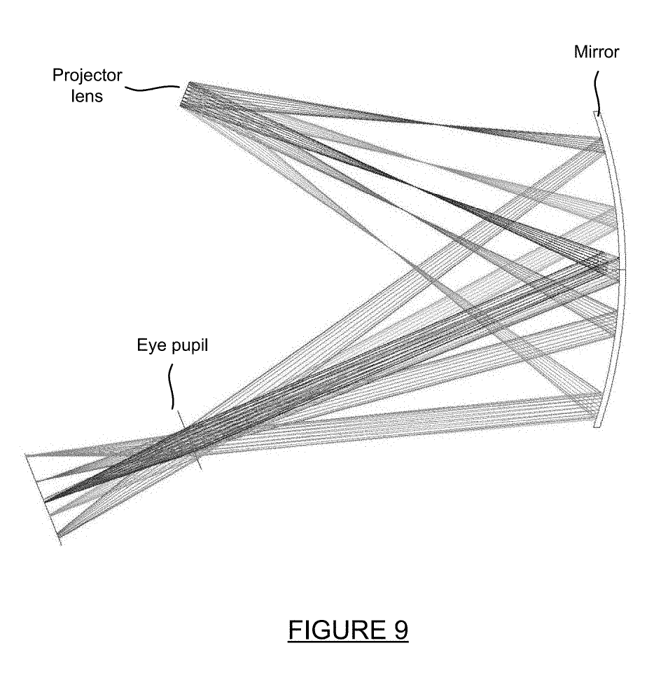

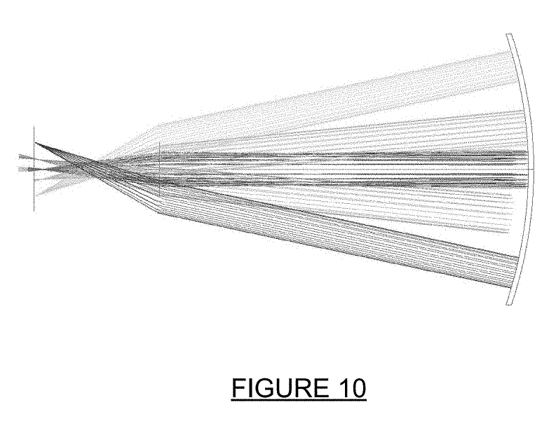

In some instances, different size mirrors may be used as part of the near eye projection system. FIG. 9 illustrates an optical signal pattern for another head mount display near-eye projection system. The optical signal pattern of FIG. 9 may be associated with a near eye projection system that utilizes a smaller mirror. The projector lens may project light and received by a smaller mirror. The smaller mirror may reflect light towards a user's pupil. As shown, the split beams may have a different pattern than that associated with a larger mirror. FIG. 10 illustrates a side view of the optical signal pattern for the head mount display near-eye projection system associated with FIG. 9. The optical signal pattern of FIG. 10 illustrates the vertical spread of the beams associated with a smaller mirror.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims appended hereto.

What is claimed is:

1. A system for projecting a beam within a head mount display worn by a user, including:
a light source within the head mount display that provides light to a digital imaging circuitry;
digital imaging circuitry within the head mount display that receives the light and a digital signal and projects image data as a beam;
projection optics that project the beam; and
a mirror having a curve that reflects the projected beam to a user.

2. The system of claims 1, wherein the focal length of the mirror is less than 80 millimeters.

3. The system of claims 1, wherein the system includes a second projector, a second beam splitter, a second filter and a second mirror for projecting split, filtered beams to a second pupil of the user.

4. The system of claim 1, wherein the digital imaging circuitry or projection optics are movable to adjust a focal plane for the beam.
